(19) United States
(12) Patent Application Publication
(10) Pub. No.: US 2026/0048411 A1
(43) Pub. Date: Feb. 19, 2026

(54) SUSPENDED-TYPE SMART PAINTING APPARATUS FOR BUILDING WALL SURFACE

(71) Applicant: Kai Yip LAU, Hong Kong (HK)

(72) Inventor: Kai Yip LAU, Hong Kong (HK)

(21) Appl. No.: 18/707,551

(22) PCT Filed: Apr. 18, 2023
(86) PCT No.: PCT/CN2023/088826

§ 371 Date: May 3, 2024

(30) Foreign Application Priority Data
May 24, 2022 (CN) 202210573762.5

(51) Int. Cl. B05B 15/62; B05B 7/00; B05C 1/08

(52) U.S. Cl. CPC B05B 15/62; B05B 7/0081; B05C 1/0813; B05C 1/0873

(57) ABSTRACT

A suspended-type smart painting apparatus for a building wall surface, comprising a support (1), a painting mechanism (2), a suspension and movement mechanism (3), a control mechanism (4), and a paint storage mechanism (5). The support (1) comprises a support main body (11), and an auxiliary support (12). The painting mechanism (2) comprises a support arm (21), a painting spray head (22), and a roller (23). The suspension and movement mechanism (3) comprises a reel (31), a horizontal plate (32), horizontal movement mechanisms (33) arranged at two ends of the horizontal plate (32), and a first motor (34). Each horizontal movement mechanism (33) comprises a roller wheel (331), a second motor (332), and a transmission gear (333). The control mechanism (4) comprises a microcontroller (42), an air pump (43), and a sensor group (41). The paint storage mechanism (5) comprises a storage drum (52), a one-way air valve (51), a stirring rod (53), an electromagnet array (56), and a paint outlet (57). The suspended-type smart painting apparatus for a building wall surface is reasonable in structure, has advantages such as being simple in structure, convenient to use, safe and reliable, and convenient to convey materials, and effectively solves the problem that painting high walls is unsafe.

### FIELD OF THE INVENTION

The present invention relates to the field of building decoration machinery, and more particularly to a suspended-type smart painting apparatus for a building wall surface.

### BACKGROUND OF THE INVENTION

In existing technologies, painting a wall is usually completed manually by a construction worker, which requires the construction worker to have relevant experience and skills. Otherwise, painting efficiency is low, the degree of finish is not high, and adhesion is weak, directly affecting the decoration quality of an entire house. In addition, when a tall wall is painted, a scaffold needs to be built to assist in construction. Not only construction materials are not easy to transport, and paint is easily sedimented, but also it is dangerous for the construction worker to move on the scaffold.

### SUMMARY OF THE INVENTION

A technical problem to be resolved in the present invention is as follows: to resolve the foregoing problem, a suspended-type smart painting apparatus for a building wall surface is provided. The suspended-type smart painting apparatus for a building wall surface is reasonable in structure, has advantages such as being simple in structure, convenient to use, safe and reliable, and convenient to convey materials, and effectively solves the problem that painting high walls is unsafe.

Technical solutions used to resolve the technical problem in the present invention are as follows: a suspended-type smart painting apparatus for a building wall surface, including: a support, a painting mechanism, a suspension and movement mechanism, a control mechanism, and a paint storage mechanism, where the support includes a support main body with an “I”-shaped structure and auxiliary supports respectively firmly disposed on both sides of the support main body; the auxiliary support includes two symmetrically arranged support plates and two sets of damping shafts arranged at two ends of the support plates, one support plate is firmly connected to the support main body, two ends of each set of damping shafts are respectively connected to ends that are of the two support plates and that face the same direction, to form a square structure.

The painting mechanism includes a support arm, a painting spray head, and a roller; the support arm has a hollow structure, one end of the support arm is hingedly connected to the auxiliary support, and the other end of the support arm is firmly connected to the painting spray head and is rotatably connected to the roller; the painting spray head has a hollow arc-shaped plate structure, several spray openings are evenly provided on an inner arc surface of the painting spray head, and the spray openings directly face the roller.

The suspension and movement mechanism includes a reel, a horizontal plate, horizontal movement mechanisms disposed at two ends of the horizontal plate, and a first motor; the reel is disposed between the two support plates of the auxiliary supports and is rotatably connected to the two support plates; the first motor is symmetrically and firmly disposed at two ends of the support main body and is connected to the reel in a transmission manner; a cable in a vertical direction is connected to the reel, and the other end of the cable is respectively wound around the damping shaft and connected to the two ends of the horizontal plate.

The horizontal movement mechanism includes a pair of roller wheels arranged symmetrically up and down and hinged with the horizontal plate, a second motor, and a transmission gear; the roller wheel is provided with a groove, a horizontal cable is inserted into the groove, the second motor is firmly disposed on the horizontal plate, and the second motor is connected to the roller wheel in a transmission manner through the transmission gear.

The control mechanism includes a microcontroller, an air pump, and a sensor group that is disposed on an upper-end surface of the support main body; the sensor group includes a distance sensor, a lighting lamp, and a camera.

The paint storage mechanism includes a circular storage drum disposed on a lower-end surface of the support main body, a one-way air valve disposed on the storage drum, a stirring rod, an electromagnet array, and a paint outlet; one end of the stirring rod is connected to the storage drum through a ball joint, and the other end of the stirring rod is bent downward and firmly provided with a magnet; the electromagnet array is made of several electromagnets laid radially on a bottom of the storage drum.

An air outlet of the air pump is connected to the one-way air valve, the paint outlet is connected to one end of a feeding pipe, and the other end of the feeding pipe passes through an inner cavity of the support arm and is connected to an inner cavity of the painting spray head.

Further, there are two damping shafts in each group, and the cable in the vertical direction passes between and abuts against the two damping shafts.

Further, the groove of the roller wheel is coated or sleeved with a rubber layer.

Further, the magnet is of a thin sheet structure, and a bottom of the magnet abuts against the bottom surface of an inner cavity of the storage drum.

Further, the lower-end surface of the support main body is provided with a connecting protrusion, and the circular storage drum is threadedly connected to the connecting protrusion.

Further, the microcontroller is electrically connected to the first motor, the second motor, the sensor group, and the air pump separately, and the microcontroller is connected to an external power supply.

The beneficial effects of the present invention are as follows: The suspended-type smart painting apparatus for a building wall surface includes the support, the painting mechanism, the suspension and movement mechanism, the control mechanism, and the paint storage mechanism. The stirring rod is disposed in the paint storage mechanism to stir the paint, which can effectively prevent the paint from sinking. The painting mechanism uses the air pump to transport the paint to the roller. The roller abuts against and rolls with the wall, and the paint is evenly applied on the wall surface. The suspension and movement mechanism drives the present invention to move in a vertical plane and a horizontal plane, which can not only transport the paint for painting but also utilize the painting mechanism to complete wall surface painting during continuous movement. The suspended-type smart painting apparatus for a building wall surface is reasonable in structure, has advantages such as being simple in structure, convenient to use, safe and reliable, and convenient to convey materials, and effectively solves the problem that painting high walls is unsafe.

### BRIEF DESCRIPTION OF THE DRAWINGS

The present invention will be further described with reference to the accompanying drawings and embodiments.

FIG. 1 is a schematic diagram of a front structure of a suspended-type smart painting apparatus for a building wall surface according to the present invention;

FIG. 2 is a schematic diagram of a side structure of a suspended-type smart painting apparatus for a building wall surface according to the present invention;

FIG. 3 is a schematic diagram of a connection structure between an auxiliary support and a roller of a suspended-type smart painting apparatus for a building wall surface according to the present invention;

FIG. 4 is a schematic diagram of a structure of a painting spray head of a suspended-type smart painting apparatus for a building wall surface according to the present invention;

FIG. 5 is a schematic diagram of a structure of a horizontal movement mechanism of a suspended-type smart painting apparatus for a building wall surface according to the present invention; and

FIG. 6 is a schematic diagram of a structure of a paint storage mechanism and a support main body of a suspended-type smart painting apparatus for a building wall surface according to the present invention.

Reference numerals are as follows:

1. support, 11. support main body, 111. connecting protrusion, 12. auxiliary support, 121. damping shaft, 122. support plate, 2. painting mechanism, 21. support arm, 22. painting spray head, 221. spray opening, 23. roller, 3. suspension and movement mechanism, 31. reel, 32. horizontal plate, 33. horizontal movement mechanism, 331. roller wheel, 332. second motor, 333. transmission gear, 34. first motor, 4. control mechanism, 41. sensor group, 42. microcontroller, 43. air pump, 5. paint storage mechanism, 51. one-way air valve, 52. circular storage drum, 53. stirring rod, 54. magnet, 55. ball joint, 56. electromagnet array, 57. paint outlet.

### DETAILED DESCRIPTION OF PREFERRED EMBODIMENTS

The present invention will now be further described more specifically with reference to the accompanying drawings. These drawings are simplified schematic diagrams that only describe a basic structure of the present invention in a schematic manner, and therefore only show compositions related to the present invention.

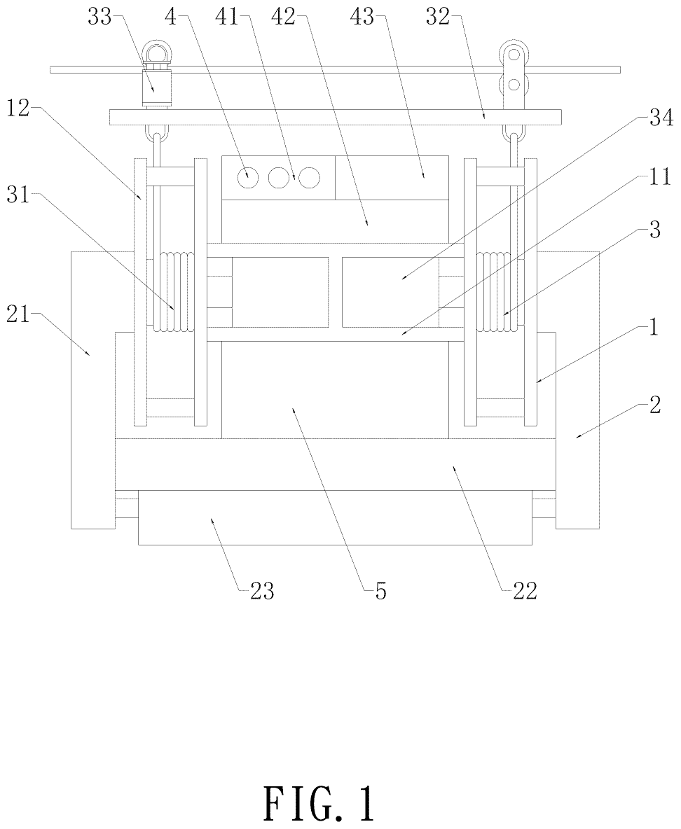

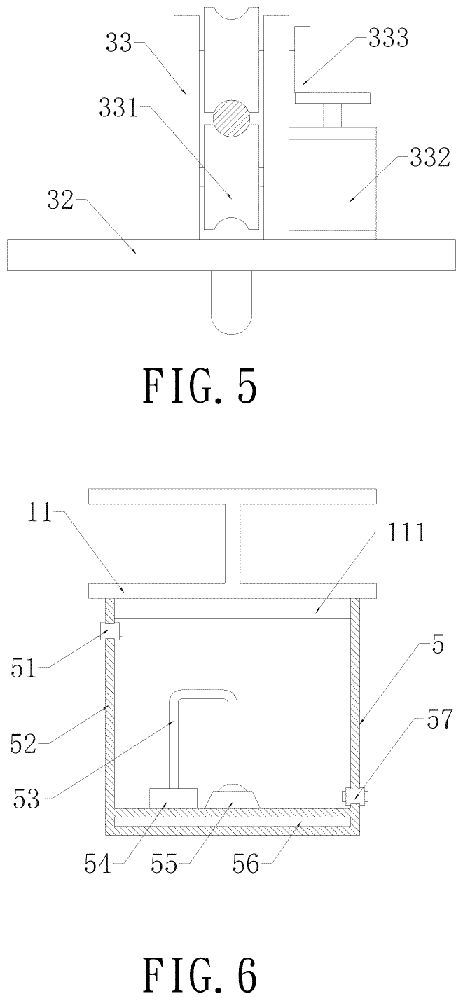

A suspended-type smart painting apparatus for a building wall surface as shown in FIG. 1 to FIG. 6 includes a support 1, a painting mechanism 2, a suspension and movement mechanism 3, a control mechanism 4, and a paint storage mechanism 5. The support 1 includes a support main body 11 with an “I”-shaped structure and auxiliary supports 12 respectively firmly disposed on both sides of the support main body 11.

As shown in FIG. 3, the auxiliary support 12 includes two symmetrically arranged support plates 122 and two sets of damping shafts 121 arranged at two ends of the support plates 122. One support plate is firmly connected to the support main body 11. Two ends of each set of damping shafts 121 are respectively connected to the ends that are of the two support plates 122 and that face a same direction, to form a square structure.

The painting mechanism 2 shown in FIG. 1 includes a support arm 21, a painting spray head 22, and a roller 23. The support arm 21 has a hollow structure. One end of the support arm 21 is hingedly connected to the auxiliary support 12, and the other end of the support arm 21 is firmly connected to the painting spray head 22 and is rotatably connected to the roller 23.

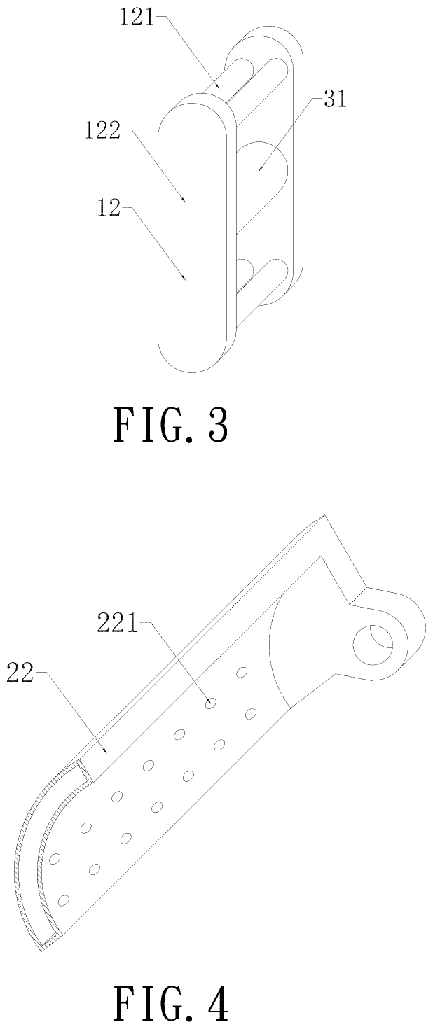

As shown in FIG. 4, the painting spray head 22 has a hollow arc-shaped plate structure. Several spray openings 221 are evenly provided on an inner arc surface of the painting spray head 22, and the spray openings 221 directly face the roller 23.

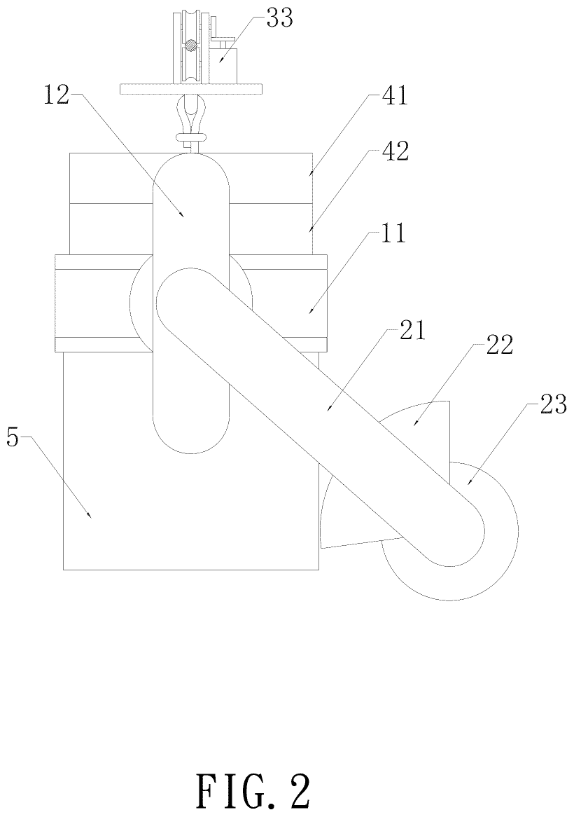

As shown in FIG. 1 and FIG. 2, the suspension and movement mechanism 3 includes a reel 31, a horizontal plate 32, horizontal movement mechanisms 33 disposed at two ends of the horizontal plate 32, and a first motor 34.

As shown in FIG. 3, the reel 31 is disposed between the two support plates 122 of the auxiliary supports 12 and is rotatably connected to the two support plates 122.

As shown in FIG. 1, the first motor 34 is symmetrically and firmly disposed at two ends of the support main body 11 and is connected to the reel 31 in a transmission manner. A cable in a vertical direction is connected to the reel 31, and the other end of the cable is respectively wound around the damping shaft 121 and connected to the two ends of the horizontal plate 32.

In one embodiment, a lower end of the vertical cable is directly connected to the reel 31, and an upper end of the vertical cable is connected to the horizontal plate 32. The reel 31 is used to produce a lifting effect on the vertical cable. In another embodiment, a lower end of the vertical cable is connected to a ground or a counterweight to make the vertical cable straight, a middle section of the vertical cable is directly connected to the reel 31, and an upper end of the vertical cable is connected to the horizontal plate 32. A friction between the reel 31 and the vertical cable is used for movement in a vertical direction.

The horizontal movement mechanism 33 includes a pair of roller wheels 331 arranged symmetrically up and down and hinged with the horizontal plate 32, a second motor 332, and a transmission gear 333. The roller wheel 331 is provided with a groove, and a horizontal cable is inserted into the groove. The second motor 332 is firmly disposed on the horizontal plate 32, and the second motor 332 is connected to the roller wheel 331 in a transmission manner through the transmission gear 333. The roller wheel 331 moves horizontally through friction between the roller wheel and the horizontal cable.

As shown in FIG. 1, the control mechanism 4 includes a microcontroller 42, an air pump 43, and a sensor group 41 that are disposed on an upper-end surface of the support main body 11. The sensor group 41 includes a distance sensor, a lighting lamp, and a camera. The distance sensor determines a distance from the wall, the lighting lamp assists in lighting, and the camera transmits image data to an external device to observe the painting effect.

As shown in FIG. 6, the paint storage mechanism 5 includes a circular storage drum 52 disposed on a lower-end surface of the support main body 11, a one-way air valve 51 disposed on the circular storage drum 52, a stirring rod 53, an electromagnet array 56, and a paint outlet 57. One end of the stirring rod 53 is connected to the storage drum 52 through a ball joint 55, and the other end of the stirring rod 53 is bent downward and firmly provided with a magnet 54. The electromagnet array 56 is made of several electromagnets laid radially on the bottom of the circular storage drum 52. Adjacent individuals in the electromagnet array 56 in the same direction work sequentially within the same time interval. For example, the electromagnet array 56 includes 12 electromagnet individuals and the working direction is clockwise, starting from an individual in a one o'clock direction, and only one individual starts working at a time. The order of the working individuals is: a one o'clock direction, a two o'clock direction, a three o'clock direction, a four o'clock direction . . . , and so on.

An air outlet of the air pump 43 is connected to the one-way air valve 51, and the paint outlet 57 is connected to one end of a feeding pipe. An air pressure generated by the air pump 43 is used to increase the pressure in the circular storage drum 52. The other end of the feeding pipe passes through an inner cavity of the support arm 21 and is connected to an inner cavity of the painting spray head 22. High pressure in the circular storage drum 52 is used to transport paint to the painting spray head 22, and the painting spray head 22 sprays the paint onto the roller 23, and the roller 23 rolls with the wall to apply paint.

In one embodiment, there are two damping shafts 121 in each group, and the cable in the vertical direction passes between and abuts against the two damping shafts 121. If the reel 31 rotates extremely fast, the damping shafts 121 generate a damping force on the vertical cable for a slow-down, preventing the present invention from stalling and falling. In addition, the damping shaft 121 also plays a guiding role in cooperation with the vertical cable.

In one embodiment, the groove of the roller wheel 331 is coated or sleeved with a rubber layer.

In one embodiment, the magnet 54 is of a thin sheet structure, and a bottom of the magnet 54 abuts against a bottom surface of an inner cavity of the circular storage drum 52.

In one embodiment, a lower-end surface of the support main body 11 is provided with a connecting protrusion 111, and the circular storage drum 52 is threadedly connected to the connecting protrusion 111.

In one embodiment, the microcontroller 42 is electrically connected to the first motor 34, the second motor 332, the sensor group 41, and the air pump 43 separately, and the microcontroller 42 is connected to an external power supply.

When the present invention is used, first, the horizontal cable is disposed at the top of a high wall, and the horizontal cable is connected to the horizontal movement mechanism 33. After the paint is filled, the suspension and movement mechanism 3 is used to lift the present invention, the sensor group 41 determines the distance from the wall, and the air pump 43 starts to deliver the paint to the surface of the roller 23. The present invention starts to move up and down to paint a wall surface with a specific area in the vertical direction. After the wall surface with a specific area in the vertical direction is painted, the horizontal movement mechanism 33 drives the present invention to move horizontally a specific distance and then continues to paint the next wall surface in the vertical direction. During painting, image information is sent to a controller through the camera to observe the painting effect. If it is observed that the paint is used up, the present invention drops to the ground to add a new paint and continue working.

The suspended-type smart painting apparatus for a building wall surface described in the present invention has a proper structure, including the support, the painting mechanism, the suspension and movement mechanism, the control mechanism, and the paint storage mechanism. The stirring rod is disposed in the paint storage mechanism to stir the paint, which can effectively prevent the paint from sinking. The painting mechanism uses the air pump to transport the paint to the roller. The roller abuts against and rolls with the wall, and the paint is evenly applied on the wall surface. The suspension and movement mechanism drives the present invention to move in a vertical plane and a horizontal plane, which can not only transport the paint for painting but also utilize the painting mechanism to complete wall surface painting during continuous movement. The suspended-type smart painting apparatus for a building wall surface is reasonable in structure, has advantages such as being simple in structure, convenient to use, safe and reliable, and convenient to convey materials, and effectively solves the problem that painting high walls is unsafe.

Ideal embodiments of the present invention are used as enlightenment, relevant workers can completely make various changes and modifications without departing from the scope of the technical idea of the present invention. The technical scope of the present invention is not limited to the content in the specification, and needs to be determined based on the scope of the claims.

What is claimed is:

1. A suspended-type smart painting apparatus for a building wall surface, comprising: a support (1), a painting mechanism (2), a suspension and movement mechanism (3), a control mechanism (4), and a paint storage mechanism (5), wherein the support (1) comprises a support main body (11) with an I-shaped structure and auxiliary supports (12) respectively firmly disposed on both sides of the support main body (11), the auxiliary support (12) comprises two symmetrically arranged support plates (122) and two sets of damping shafts (121) arranged at two ends of the support plates (122), wherein one of the support plates is firmly connected to the support main body (11), two ends of each set of damping shafts (121) are respectively connected to ends that are of the two support plates (122) and that face a same direction to form a square structure;
the painting mechanism (2) comprises a support arm (21), a painting spray head (22), and a roller (23), wherein the support arm (21) has a hollow structure, one end of the support arm (21) is hingedly connected to the auxiliary support (12), and the other end of the support arm (21) is firmly connected to the painting spray head (22) and is rotatably connected to the roller (23), the painting spray head (22) has a hollow arc-shaped plate structure, several spray openings (221) are evenly provided on an inner arc surface of the painting spray head (22), and the spray openings (221) directly face the roller (23);
the suspension and movement mechanism (3) comprises a reel (31), a horizontal plate (32), horizontal movement mechanisms (33) disposed at two ends of the horizontal plate (32), and a first motor (34), the reel (31) is disposed between the two support plates (122) of the auxiliary supports (12) and is rotatably connected to the two support plates (122), the first motor (34) is symmetrically and firmly disposed at two ends of the support main body

(11) and is connected to the reel (31) in a transmission manner, a cable in a vertical direction is connected to the reel (31), and the other end of the cable is respectively wound around the damping shaft (121) and connected to the two ends of the horizontal plate (32);
the horizontal movement mechanism (33) comprises a pair of roller wheels (331) arranged symmetrically up and down and hinged with the horizontal plate (32), a second motor (332), and a transmission gear (333), the roller wheel (331) is provided with a groove, a horizontal cable is inserted into the groove, the second motor (332) is firmly disposed on the horizontal plate (32), and the second motor (332) is connected to the roller wheel (331) in a transmission manner through the transmission gear (333);
the control mechanism (4) comprises a microcontroller (42), an air pump (43), and a sensor group (41) that are disposed on an upper-end surface of the support main body (11), and the sensor group (41) comprises a distance sensor, a lighting lamp, and a camera;
the paint storage mechanism (5) comprises a circular storage drum (52) disposed on a lower-end surface of the support main body (11), a one-way air valve (51) disposed on the circular storage drum (52), a stirring rod (53), an electromagnet array (56), and a paint outlet (57), one end of the stirring rod (53) is connected to the circular storage drum (52) through a ball joint (55), and the other end of the stirring rod (53) is bent downward and firmly provided with a magnet (54), and the electromagnet array (56) is made of several electromagnets laid radially on a bottom of the circular storage drum (52); and
an air outlet of the air pump (43) is connected to the one-way air valve (51), the paint outlet (57) is connected to one end of a feeding pipe, and the other end of the feeding pipe passes through an inner cavity of the support arm (21) and is connected to an inner cavity of the painting spray head (22).

2. The suspended-type smart painting apparatus for a building wall surface according to claim 1, wherein there are two damping shafts (121) in each group, and the cable in the vertical direction passes between and abuts against the two damping shafts (121).

3. The suspended-type smart painting apparatus for a building wall surface according to claim 1, wherein the groove of the roller wheel (331) is coated or sleeved with a rubber layer.

4. The suspended-type smart painting apparatus for a building wall surface according to claim 1, wherein the magnet (54) is of a thin sheet structure, and a bottom of the magnet (54) abuts against a bottom surface of an inner cavity of the circular storage drum (52).

5. The suspended-type smart painting apparatus for a building wall surface according to claim 1, wherein the lower-end surface of the support main body (11) is provided with a connecting protrusion (111), and the circular storage drum (52) is threadedly connected to the connecting protrusion (111).

6. The suspended-type smart painting apparatus for a building wall surface according to claim 1, wherein the microcontroller (42) is electrically connected to the first motor (34), the second motor (332), the sensor group (41), and the air pump (43) separately, and the microcontroller (42) is connected to an external power supply.
